(19) United States
(12) Patent Application Publication
(10) Pub. No.: US 2017/0255124 A1
(43) Pub. Date: Sep. 7, 2017

(54) Digital Printing Apparatus and Method Using Liquid Toner

(71) Applicant: Xeikon Manufacturing N.V., Lier (BE)

(72) Inventors: Kristiaan Gustavus Carolina Nuyts, Sint-Amands (BE); Romain Jan Victor Paul Van Der Gucht, Lint (BE)

(21) Appl. No.: 15/445,024

(22) Filed: Feb. 28, 2017

(30) Foreign Application Priority Data
Mar. 1, 2016 (NL) 2016339

(51) Int. Cl. G03G 15/01

(52) U.S. Cl. CPC G03G 15/065; G03G 15/10

(57) ABSTRACT

A digital printing apparatus using liquid toner including a carrier liquid, a dispersing agent and imaging particles. The apparatus includes a first image forming unit for a first colour; a second image forming unit for a second colour, and a substrate support assembly for supporting the substrate during the subsequent transfer of first and second liquid toner from the first and second image forming unit to the substrate. The second image forming unit is arranged downstream of the first image forming unit along the substrate support assembly. The first image forming unit and the substrate support assembly are arranged such that the substrate is compressed in a first nip between the first image forming unit and the substrate support assembly. A control mechanism adjusts the first and/or second pattern to compensate for the increased width of the substrate downstream of the first image forming unit.

### CROSS-REFERENCE TO RELATED APPLICATION

This application claims priority to Dutch Patent Application No. 2016339 filed Mar. 1, 2016, the disclosure of which is hereby incorporated in its entirety by reference.

### FIELD OF INVENTION

The field of the invention relates to digital printing apparatus and methods using liquid toner comprising carrier liquid, a dispersing agent and imaging particles.

### BACKGROUND

Prior art digital printing apparatus using liquid toner typically comprise an image forming unit with an imaging member adapted to sustain a pattern of electric charge forming a latent image on its surface, a development member arranged to receive liquid toner, and to develop said latent image by transferring a portion of said liquid toner onto the imaging member in accordance with said pattern. The liquid toner is then applied from the imaging member on the substrate, optionally via an intermediate member.

It is known that for substrates, especially for paper, there may be a shrinkage or elongation of the substrate in mutually perpendicular directions due to changes in the relative humidity of the substrate. It is known to perform correcting for colour misregistration by applying processing on the control signals provided to the recording head. Further, other techniques exist for reducing elongation or shrinkage of the substrate.

The present invention does not deal with elongation or shrinkage of the substrate due to changes of the relative humidity. However, the inventors have noted that also when the relative humidity of the substrate is not significantly modified, colour misregistration problems may exist.

### SUMMARY

An object of embodiments of the invention is to provide a digital printing apparatus and method using liquid toner which allows for printing without colour alignment problems in high speed printing apparatus and methods with various types of substrates.

According to a first aspect of the invention, there is provided a digital printing apparatus using liquid toner comprising carrier liquid, a dispersing agent and imaging particles. The apparatus comprises a first image forming unit for a first colour, a second image forming unit for a second colour, a substrate support assembly, and a control mechanism. The first image forming unit comprises a first imaging member adapted to sustain a first pattern of electric charge forming a first latent image on its surface; a first development member arranged to receive first liquid toner of the first colour, and to develop said first latent image by transferring a portion of said first liquid toner onto said first imaging member in accordance with said first pattern. The second image forming unit comprises a second imaging member adapted to sustain a second pattern of electric charge forming a second latent image on its surface; a second development member arranged to receive second liquid toner in the second colour, and to develop said second latent image by transferring a portion of said second liquid toner onto said second imaging member in accordance with said second pattern. The substrate support assembly is configured for supporting the substrate during the subsequent transfer of first and second liquid toner from the first and second image forming unit to the substrate, whilst the substrate moves in a movement direction from the first to the second image forming unit. The second image forming unit is arranged downstream of the first image forming unit along the substrate support assembly. The first image forming unit and the substrate support assembly are arranged such that the substrate is compressed when first liquid toner is transferred to the substrate in a first nip between the first image forming unit and the substrate support assembly, resulting in an increased width of the substrate downstream of said first image forming unit, seen in a direction perpendicular on the movement direction of the substrate. The control mechanism is configured for adjusting said first and/or second pattern in order to compensate for the increased width of the substrate downstream of said first image forming unit.

By adjusting the first and/or second pattern, notwithstanding the width increase of the substrate due to the pressure exerted on the substrate, the first and the second pattern may be aligned. This will allow having high pressures when transferring an image from a member of the first image forming unit to the substrate, resulting in improved printing qualities on various types of substrates without misalignment problems.

Embodiments of the invention are based inter alia on the inventive insight that the quality of the transfer from a member of an image forming unit to the substrate can be significantly improved by increasing the pressure exerted on the substrate during the transfer. During the transfer itself the substrate is clamped in a nip between a member of an image forming unit and a member of the substrate support assembly. While the substrate goes through the nip, an expansion of the substrate in a direction perpendicular on the movement direction takes place when the substrate is being compressed with a very high pressure. Embodiments of the present invention are at least partially based on this insight.

In an exemplary embodiment the first image forming unit comprises a first intermediate member between the first imaging member and the substrate support assembly, and the second image forming unit comprises a second intermediate member between the second imaging member and the substrate support assembly. Using first and second intermediate members the transfer from the first and second imaging members to the substrate can be further improved. Such first and second intermediate members will allow using a configuration where the first and second intermediate members, typically rollers, are pressed against the substrate support assembly, e.g. a support roller for each intermediate roller or a single common larger support roller for all intermediate members, so that a relatively high pressure is available in the nip between the first/second intermediate member and the substrate support assembly. In other embodiments there may be provided a direct transfer from the first and second imaging members to the substrate, without the use of intermediate members.

In an exemplary embodiment the substrate support assembly comprises a first support member, e.g. a first roller, and a second support member, e.g. a second roller. The first support member is arranged in rotating contact with the first intermediate member or with the first imaging member. The second support member is arranged in rotating contact with the second intermediate member or with the second imaging member. In that manner the substrate is compressed between the first support member and the first intermediate member or the first imaging member and between the second support member and the second intermediate member or the second imaging member.

In an exemplary embodiment the control mechanism is configured to add pixels to the second pattern to compensate for the increased width of the substrate downstream of the first image forming unit. Another possibility would be to adjust the first pattern or to adjust the first and second pattern. However, adding pixels to the second pattern can be performed in a relatively easy and fast manner without losing pixels, and therefore is preferred. Depending on the measured or predicted width increase due to the passage through the first image forming unit, a suitable number of pixels may be added in every line of the second pattern. These additional dummy pixels may be evenly distributed, and the value of the dummy pixel may be determined e.g. by replicating an adjacent left or right pixel value or by performing an interpolation between at least one adjacent left and right pixel value. More generally the value of the dummy pixel may be determined based on one or more values of one or more neighbouring pixels.

In an exemplary embodiment the digital printing apparatus further comprises a sensing mechanism configured to sense a measure representative for the width of the substrate downstream of the first image forming unit; and the control mechanism is configured to adjust the first and/or second pattern in function of the sensed measure. Preferably, the control mechanism is configured to adjust the second pattern in function of the sensed measure. Preferably, the sensing mechanism comprises at least one camera.

In an exemplary embodiment the sensing mechanism is configured to measure, downstream of the first image forming unit, in a direction perpendicular on the movement direction of the substrate, a distance between left and right marks printed by the first image forming unit. Such a distance may be used to calculate the width elongation of the printable area of the substrate, and hence to calculate the necessary adjustment to the second and/or first pattern. Preferably left and right marks are printed along opposite longitudinal edges of the substrate, in the margins of the substrate.

In an exemplary embodiment the sensing mechanism comprises a first sensor configured to sense a first measure representative for the width of the substrate downstream of the first image forming unit and upstream of the second image forming unit; and/or a second sensor configured to sense a second measure representative for the width increase of the substrate due to the passage through the second image forming unit. The control mechanism is configured to adjust the first and/or second pattern in function of the first and/or second sensed measure. Preferably the second sensor is configured to sense a position difference, seen in a width direction perpendicular to the movement direction of the substrate, between a first mark printed in the first colour and a second mark printed in the second colour. In other words, the first sensor may perform an absolute measurement, e.g. a measurement of a distance between a left and a right mark printed in the first colour, and the width increase due to the passage through the first image forming unit may be calculated using the known width intended to be printed and the measured value. The second sensor may perform a relative measurement, e.g. a measurement of a distance between a first mark in a first colour and a second mark in a second colour, to calculate the further width elongation due to the passage through the second image forming unit.

In an exemplary embodiment the digital printing apparatus further comprises an image processing system for generating control signals for the first and second image forming unit, from source image data from an image source. The image processing system comprises a raster image processing module configured to convert said source image data into a bitmap, and a streaming processor configured to receive said bitmap and to generate control signals for the first and second image forming unit based on said bitmap. Preferably, the control mechanism is implemented in the streaming processor. More in particular the streaming processor may be controlled to add pixels in the bitmap for the second colour.

In an exemplary embodiment the streaming processor is further configured to receive instruction signals and to use said instruction signals for generating additional printing marks, such as cut marks or a calibration strip, in a printed image. These marks may include left and right marks used for performing the above mentioned measurements by the sensing mechanism.

In an exemplary embodiment, a substrate is arranged between the first image forming unit and the substrate support assembly. More in particular the digital printing apparatus may comprise a roll of substrate, and the substrate may be arranged as a so-called “continuous” web from the roll of substrate (e.g., paper, plastic foil, or a multi-layer combination thereof). Preferably, the substrate, the first image forming unit and the substrate support assembly are arranged and configured such that the first nip has a length, seen in the direction of movement of the substrate, which is bigger than 6 mm, preferably bigger than 7 mm, more preferably bigger than 8 mm, e.g. bigger than 9 mm. Preferably the first nip has a length between 6 and 15 mm, more preferably between 7 and 14 mm, most preferably between 8 and 13 mm, e.g. between 9 and 12 mm. These nip dimensions apply with the substrate in place between the first image forming unit and the substrate support assembly. With such a first nip length, the compression of the substrate results typically in an increase of the width of the substrate, in a direction perpendicular on the direction of movement of the substrate, of more than 1 mm per 50 cm, preferably more than 2 mm per 50 cm. Preferably the increase of the width of the substrate is 1-4 mm per 50 cm, more preferably 2-3 mm per 50 cm. Preferably, the first image forming unit and the substrate support assembly are configured to compress of the substrate such that the increase of the width of the substrate is above 1 mm per 50 cm, more preferably above 2 mm per 50 cm. A second nip between the second image forming unit and the substrate support assembly may have similar dimensions.

According to another aspect of the invention, there is provided a digital printing method using liquid toner comprising carrier liquid, a dispersing agent and imaging particles. The method comprises: developing a first latent image by transferring first liquid toner having a first colour onto a first imaging member of a first image forming unit, in accordance with a first pattern of electric charges; and transferring first liquid toner from the first imaging member to a substrate; developing a second latent image by transferring second liquid toner having a second colour onto a second imaging member of a second image forming unit, in accordance with a second pattern of electric charges; and transferring second liquid toner from the second imaging member to the substrate. The substrate is compressed in a first nip when first liquid toner is transferred to the substrate, resulting in an increased width of the substrate downstream of said first image forming unit, seen in a direction perpendicular on a movement direction of the substrate from the first to the second image forming unit. The method further comprises adjusting said first and/or second pattern in order to compensate for the increased width of the substrate downstream of said first image forming unit.

In an exemplary embodiment the adjusting comprises adding pixels to the second pattern to compensate for the increased width of the substrate downstream of said first image forming unit.

In an exemplary embodiment the method further comprises sensing a measure representative for the width of the substrate downstream of the first image forming unit; and wherein the adjusting comprises adjusting the first and/or second pattern in function of the sensed measure.

In an exemplary embodiment the sensing comprises measuring, downstream of the first image forming unit, a distance between left and right marks printed by the first image forming unit, in a direction perpendicular on the movement direction of the substrate.

In an exemplary embodiment the sensing comprises sensing a first measure representative for the width of the substrate downstream of the first image forming unit and upstream of the second image forming unit; and/or sensing a second measure representative for the width increase of the substrate downstream of the second image forming unit; and the adjusting comprises adjusting the first and/or second pattern in function of the first and/or second sensed measure.

In an exemplary embodiment the method further comprises: converting source image data into a bitmap; and generating control signals for the first and second image forming unit based on said bitmap. Preferably, the adjusting comprises adjusting said bitmap before said control signals are being generated.

According to an embodiment the measuring is done using a camera.

According to an embodiment instruction signals are received and used for generating additional printing marks, such as marks for the above mentioned distance measurements, cut marks or a calibration strip, in the printed image.

In an exemplary embodiment of the method the first nip has a length, seen in the direction of movement of the substrate, which is bigger than 6 mm, preferably bigger than 7 mm, more preferably bigger than 8 mm, e.g. bigger than 9 mm. Preferably the first nip has a length between 6 and 15 mm, more preferably between 7 and 14 mm, most preferably between 8 and 13 mm, e.g. between 9 and 12 mm. Preferably, the compression of the substrate is such that it results in an increase of the width of the substrate, in a direction perpendicular on the direction of movement of the substrate, of more than 1 mm per 50 cm, preferably more than 2 mm per 50 cm. Preferably the increase of the width of the substrate is 1-4 mm per 50 cm, more preferably 2-3 mm per 50 cm. A second nip between the second image forming unit and the substrate support assembly may have similar dimensions.

According to another aspect there is provided a digital data storage medium encoding a machine-executable program of instructions to perform at least the adjusting step of a method according to any one of the previous embodiments, when the program is run on a computer. According to a further aspect of the invention, there is provided a computer program comprising computer-executable instructions to perform at least the adjusting step of a method according to any one of the previous embodiments, when the program is run on a computer. According to a further aspect of the invention, there is provided a computer device or other hardware device programmed to perform one or more steps of any one of the embodiments of the method disclosed above.

### BRIEF DESCRIPTION OF THE FIGURES

The accompanying drawings are used to illustrate presently preferred non-limiting exemplary embodiments of devices of the present invention. The above and other advantages of the features and objects of the invention will become more apparent and the invention will be better understood from the following detailed description when read in conjunction with the accompanying drawings, in which:

FIG. 1 is block diagram of an exemplary embodiment of a digital printing apparatus;

FIGS. 2A and 2B illustrate schematically a view of a printed pattern, without correction and with correction, respectively;

FIG. 3 illustrates schematically the sensing of a printed pattern immediately after having printed left and right marks in a first colour, and after having printed left and right marks in four colours;

FIG. 4 is block diagram of an exemplary embodiment of an image processing system;

FIG. 5 is a flow chart of an exemplary embodiment of a digital printing method; and

FIG. 6 is a flow chart of another exemplary embodiment of a digital printing method.

### DESCRIPTION OF EMBODIMENTS

In xerography processes operating with liquid toner, imaging particles or marking particles are supplied as solid particles suspended in a carrier liquid. The imaging particles consist of pigment grains, typically embedded in a small bead of resin. A dispersing agent or dispersant is added to the mix to avoid clustering of the imaging particles. Dispersants deflocculate the imaging particles and reduce the viscosity of the liquid toner dispersion. The carrier liquid is typically a substantially non-polar carrier liquid. Such substantially non-polar carrier liquids may be chosen from the following group: mineral oils, low or high viscosity liquid paraffins, isoparaffinic hydrocarbons, internal or terminal alkenes and polyenes, fatty acid glycerides, fatty acid esters or vegetable oils or combinations thereof. The term ‘substantially non-polar’ is used in the context of the application to encompass entirely non-polar materials such as alkanes and non-polar materials that are slightly more polar than alkanes, such as fatty acid based materials that include a carboxyl-group. The carrier liquid may further contain variable amounts of charge control agent (CCA), wax, plasticizers, and other additives, although they also can be incorporated into the imaging particle itself. The carrier liquid may be volatile or non-volatile. An exemplary digital printing system using liquid toner is described in more detail in US patent application with publication no. 2009/0052948, the content of which is incorporated in its entirety by reference. Typically, the toner liquid may have a solid concentration between 5% and 60 wt %. The high-shear viscosity , as measured at a shear rate of 3000 s-1 at 25° C. with a cone plate geometry of C60/1° and a gap of 52 μm, is preferably in the range of 5-500 mPa·s.

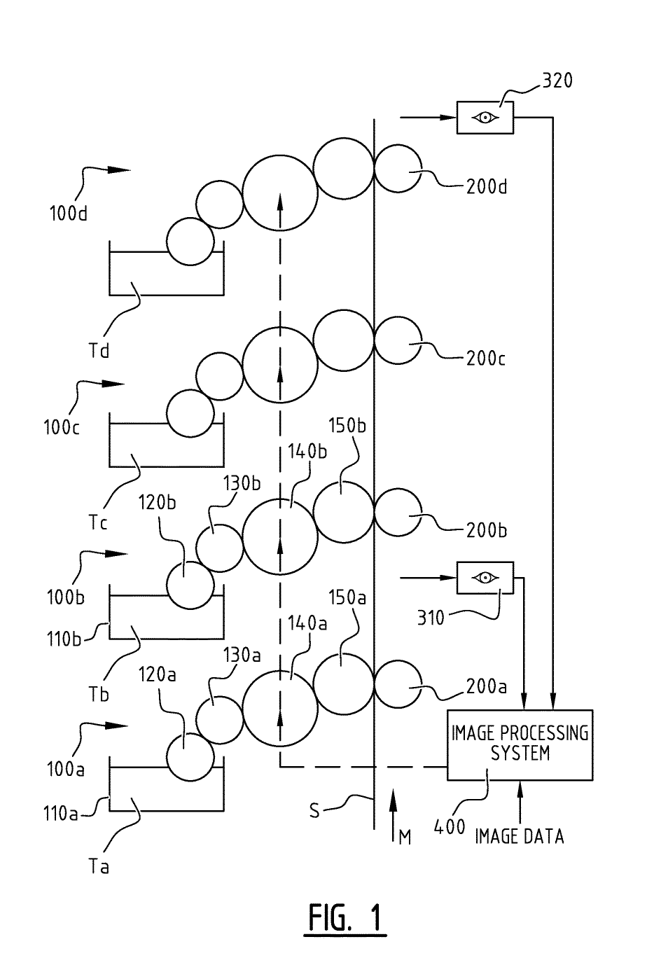

FIG. 1 illustrates schematically an exemplary embodiment of a digital printing apparatus using liquid toner. The apparatus comprises a first image forming unit 100a for applying liquid toner Ta having a first colour, e.g. black, onto a substrate S, a second image forming unit 100b for applying liquid toner Tb having a second colour, e.g. cyan, onto the substrate S, a third image forming unit 100c for applying liquid toner Tc having a third colour, e.g. magenta, onto the substrate S, and a fourth image forming unit 100d for applying liquid toner Td having a fourth colour, e.g. yellow, onto the substrate S.

The first image forming unit 100a comprises a toner reservoir 110a, a feed member 120a, a first development member 130a, a first imaging member 140a, and an optional intermediate member 150a. The first imaging member 140a is adapted to sustain a first pattern of electric charge forming a first latent image on its surface. The first development member 130a is arranged to receive first liquid toner Ta from the feed member 120a, and to develop said first latent image by transferring a portion of said first liquid toner Ta onto first imaging member 140a in accordance with said first pattern. Similarly, the second image forming unit 100b comprises a toner reservoir 110b, a feed member 120b, a second development member 130b, a second imaging member 140b, and an optional intermediate member 150b. The second imaging member 140b is adapted to sustain a second pattern of electric charge forming a second latent image on its surface. The second development member 130b is arranged to receive second liquid toner Tb from the feed member 120b, and to develop said second latent image by transferring a portion of said second liquid toner Tb onto second imaging member 140b in accordance with said second pattern. The third and fourth imaging member 100c, 100d may be implemented in a similar manner.

The substrate is supported on a substrate support assembly which comprises in the illustrated embodiment first, second, third and fourth support members 200a, 200b, 200c, 200d for supporting the substrate during the subsequent transfer of first, second, third and fourth liquid toner Ta, Tb, Tc, Td from the first, second, third and fourth image forming unit 100a, 100b, 100c, 100d, respectively, whilst the substrate moves in a movement direction M from the first image forming unit 100a to the fourth image forming unit 100d. The substrate S moves first through a first nip between the first intermediate member 150a and the first support member 200a, then through a second nip between the second intermediate member 150b and the second support member 200b, etc.

In the development stage, imaging particles travel from a development member 130a supplied with a thin, film-like layer of liquid toner Ta, onto the imaging member 140a that carries the first latent image In a subsequent step, the developed first latent image is transferred from the imaging member 140a onto the intermediate member 150a. An intermediate member 150a with a sufficiently elastic surface, e.g. a surface made of hardened rubber or a suitable elastomer, may be used when the surface of the printing substrate is not perfectly smooth, e.g. uncoated paper or a textured substrate. The elasticity of the surface of the intermediate member 150a will facilitate the deposition of an image with appropriate quality. In the final transfer step, the developed image is transferred from the intermediate roller 150a onto the substrate S, which is supported by the support roller 200a that may be kept at a suitable potential. Similar development stages apply for the second, third and fourth image forming units 100b, 100c, 100d.

The first image forming unit 100a and the first support member 200a are arranged such that the substrate is compressed when first liquid toner Ta is transferred to the substrate S, resulting in an increased width of the substrate S, seen in a direction perpendicular on the movement direction M of the substrate S, when the substrate S leaves the first image forming unit 100a. The substrate S will be further compressed between the second image forming unit 100b and the second support member 200b, between the third image forming unit 100c and the third support member 200c, and between the fourth image forming unit 100d and the fourth support member 200d. Typically, the width increase occurs while the substrate S goes through the first nip between the last member 150a of the first image forming unit 100a and the first support member 200a. A further smaller width increase may occur while the substrate S goes through the second nip between the last member 150b of the second image forming unit 100b and the second support member 200b, when the substrate S goes through the third nip between the last member of the third image forming unit 100c and the third support member 200c, and when the substrate S goes through the fourth nip between the last member of the fourth image forming unit 100d and the fourth support member 200d.

In an exemplary embodiment the first image forming unit 100a and the substrate support assembly 200a are arranged such that the first nip has a length, seen in the direction of movement of the substrate, which is bigger than 6 mm, preferably bigger than 7 mm, more preferably bigger than 8 mm, e.g. bigger than 9 mm. Preferably the first nip has a length between 6 and 15 mm, more preferably between 7 and 14 mm, most preferably between 8 and 13 mm, e.g. between 9 and 12 mm. The dimensions of the nip apply when the substrate is in place in the digital printing apparatus. The second, third and fourth nip may have similar dimensions.

With such a first nip length the first compression of the substrate results typically in an increase of the width of the substrate, in a direction perpendicular on the direction of movement of the substrate, before passing the second image forming unit 100b, of more than 1 mm per 50 cm, preferably more than 2 mm per 50 cm. Preferably the increase of the width of the substrate is 1-4 mm per 50 cm, preferably 2-3 mm per 50 cm. Typically this width increase is larger than the further width increases when passing the second, third and fourth nip.

Throughout the application, the various stages of the image forming units 100a, 100b, 100c, 100d and of the support assembly 200a, 200b, 200c, 200d have been described as members. These members may be rotating rollers, but the skilled person will appreciate that the same principles may be applied with other members, e.g. comprising a suitably designed rotating belt with a roll and/or a belt tracking shoe.

In an exemplary embodiment of the invention there is provided a control mechanism configured for adjusting said first pattern sustained on the first imaging member 140a and/or the second pattern sustained on the second imaging member 140b, in order to compensate for the increased width of the substrate downstream of said first image forming unit 100a. Typically, also the third and/or the fourth pattern are adjusted in order to at least compensate for the increased width due to the passage through the first image forming unit, and optionally also to compensate for the further width increases due to the passage through the second and third image forming unit. Such a control mechanism may be implemented in an image processing system 400 of the digital printing apparatus. Preferably, the control mechanism is configured to add pixels to the second pattern sustained on the second imaging member 140b to compensate for the increased width of the substrate S downstream of said first image forming unit 100a. In addition pixels are added to the third pattern and/or to the fourth pattern.

The digital printing apparatus may further comprise a sensing mechanism configured to sense a measure representative for the width of the substrate downstream of the first image forming unit 100a. The control mechanism may then be configured to adjust the first and/or the second and/or the third and/or the fourth pattern in function of the sensed measure. The sensing mechanism may comprise a first sensor 310 configured to sense a first measure representative for the width of the substrate S downstream of the first image forming unit 100a and upstream of the second image forming unit 100b ; and/or a second sensor 320 configured to sense a second measure representative for the width increase of the substrate downstream of the second image forming unit 100b, and preferably downstream of the fourth image forming unit 100d. The control mechanism may then be configured to adjust the first and/or second and/or third and/or fourth pattern in function of the first and/or second sensed measure.

For completeness it is noted that there may be provided a fusing station (not shown) downstream of the fourth image forming unit. The fusing may cause a shrinking of the substrate. More in particular the caused shrinkage of the width of the substrate may be more or less the same or even slightly more than the width increase caused by the passages along the first, second, third and fourth image forming stations. Alternatively or in addition, there may be provided a fusing device (not shown) downstream of each image forming unit. In such an embodiment there may be provided a first sensor as described above between a first fusing device and the second image forming unit, a second sensor between a second fusing device and the third image forming unit, etc., such that the shrinkage can also taken into account when adjusting the first and/or second and/or third and/or fourth pattern in function of the first and/or second sensed measure.

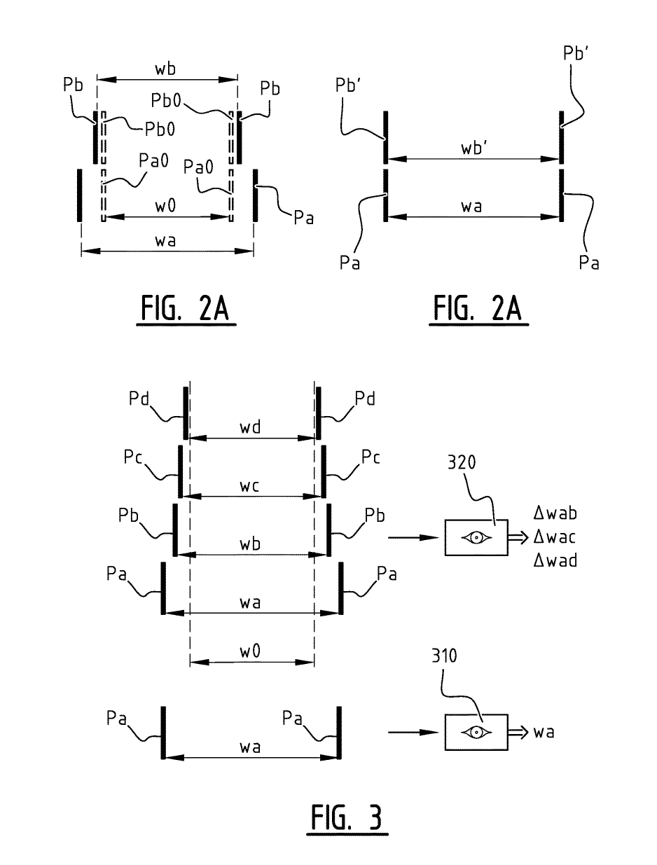

FIG. 2A illustrates left and right marks Pa, Pb printed by the first and second image forming unit 100a, 100b, respectively, without performing an adjustment of the first and second pattern. On the first imaging roller 140a, the marks Pa0 are spaced at a distance w0 from each other. However, on the substrate S, between the first and the second image forming unit 100a, 100b, due to the increase in width of the substrate, the printed marks Pa are spaced at a distance wa from each other. Similarly, on the second imaging roller 140b, the marks Pb0 are spaced at a distance w0 from each other. However, on the substrate S, between the second and the third image forming unit 100b, 100c, due to the further increase in width of the substrate S, the printed marks Pb are spaced at a distance wb from each other. Typically the width increase (wa−w0) will be larger than the width increase (wb−w0), because the increase in width of the substrate will be larger when passing the first image forming unit 100a than when passing the second image forming unit 100b. If the distance wa is sensed by the sensor 310, e.g. a camera, then this sensed value can be used to determine the width increase of the substrate S due to the passage along the first image forming unit 100a. Marks Pa, Pb could be provided e.g. in a left and right margin of the substrate. The skilled person understands that also other mark patterns are possible for determining the width increase of the substrate S.

FIG. 2B illustrates marks Pa, Pb′ printed by the first and second image forming unit 100a, 100b, respectively, when performing an adjustment of the second pattern to compensate for the increased substrate width. More in particular pixels may be added to the second pattern such that marks Pb′ are printed at a distance wb′ of each other which is equal to wa.

FIG. 3 illustrates marks Pa, Pb, Pc, Pd printed by the first, second, third, and fourth image forming unit 100a, 100b, respectively, without performing an adjustment of the first, second, third and fourth pattern. In an exemplary embodiment there is provided a sensor 310 for measuring the distance wa between left and right marks Pa. This measured value may be used to determine the width increase of the substrate S due to the passage along the first image forming unit 100a. Marks Pa could be provided e.g. in a left and right margin of the substrate. Further there may be provided a sensor 320 for measuring e.g. the distance Δwab between marks Pa and Pb, the distance Δwac between Pa and Pc and/or Δwbc between marks Pb and Pc, and the distance Δwad between Pa and Pd and/or Δwbd between Pb and Pd and/or Awcd between marks Pc and Pd. These distances, and preferably Δwab, Δwac and Δwad, may then be used to calculate the further width increases when passing the second, third and fourth image forming unit 100b, 100c, 100d, respectively.

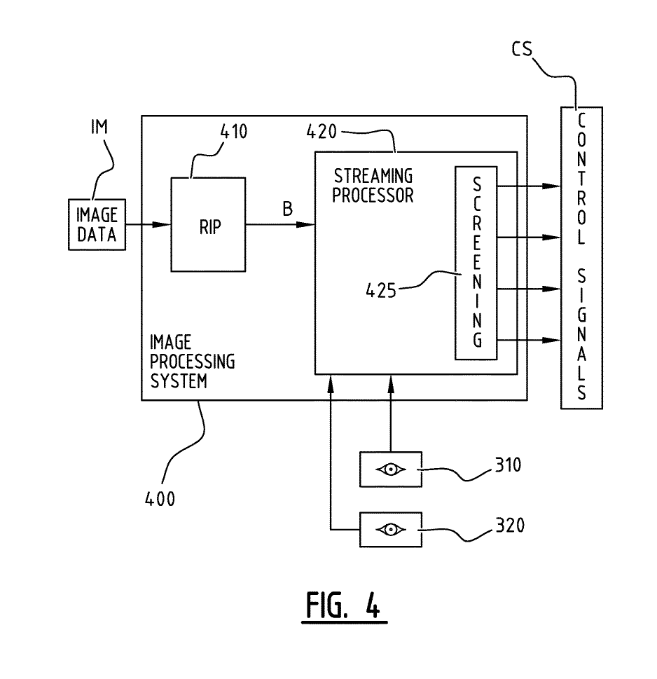

FIG. 4 illustrates an exemplary embodiment of an image processing system 400 for generating control signals CS for the image forming units, from source image data IM from an image source. The image processing system 400 comprises a raster image processor (RIP) 410 and a streaming processor 420. The RIP 410 is configured to convert the source image data IM into a bitmap B. The streaming processor 420 is configured to receive the bitmap B and to generate control signals CS for the image forming units based on said bitmap B. The above described control mechanism for adjusting the first and/or second and/or third and/or fourth pattern may be implemented in the streaming processor 420.

The raster image processor (RIP) 410 is a component used in an image processing system which produces a raster image also known as a bitmap. The input may be a page description in a high-level page description language such as PostScript, Portable Document Format, XPS or another bitmap. In the latter case, the RIP applies either smoothing or interpolation algorithms to the input bitmap to generate the output bitmap. Raster image processing is the process of turning e.g. vector digital information such as a PostScript file into a high-resolution raster image. RIPs may be implemented through hardware generating a hardware bitmap which is used to enable or disable each pixel on a real-time output device such as an optical film scanner. However, usually a RIP is implemented either as a software component of an operating system or as a firmware program executed on a microprocessor inside a printer. According to a variant a stand-alone hardware RIP may be used.

The RIP 410 may further have a layout function. When a plurality of small images needs to printed, those images may be grouped according to print patterns so that the full surface area of the substrate is used. This grouping may also be done by the RIP 410. The RIP 410 may then comprise an input interface for receiving a plurality of print jobs, each job defining e.g. an image, a cut-out contour, and a desired number of copies. The RIP 410 rips the received images and outputs the resulting bitmap or bitmaps to the streaming processor 420. Optionally, the streaming processor 420 may be further configured to receive position signals associated with the bitmap or bitmaps B. Optionally the streaming processor 420 may be further configured to receive instruction signals and to use the instruction signals for generating the control signals CS. Those instruction signals may relate to the adding of marks, such as marks Pa, Pb, Pc, Pd or cut marks or a calibration or control strip, or other data, or they may relate to calibration operations. Optionally the marks Pa, Pb, Pc, Pd may be included as a portion of the control strip, or as a portion of the cut marks.

The streaming processor 420 typically comprises a screening means 425 configured to perform a reprographic image processing technique that simulates continuous tone imagery through the use of dot clusters, varying either in size, in shape or in spacing. The adjusting of the first and/or second and/or third and/or fourth pattern is preferably done by adding a suitable number of pixels to the bitmap B in the streaming processor 420 before the screening means, i.e. between the RIP 410 and the screening means 425. Alternatively, the image data IM may be modified in the RIP 410 in order to adjust the first and/or second and/or third and/or fourth pattern.

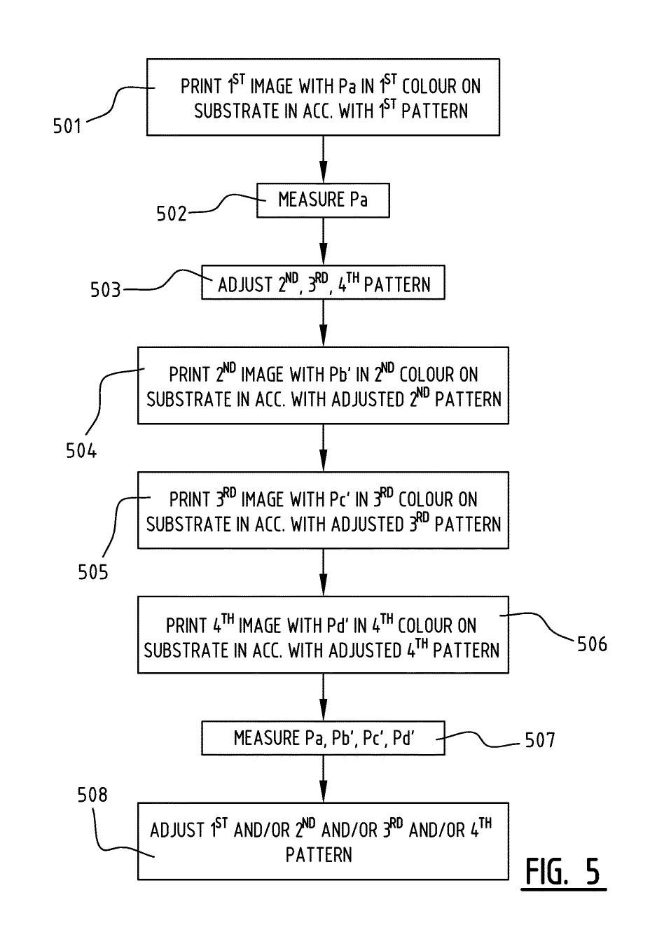

FIG. 5 illustrates an exemplary embodiment of a digital printing method using liquid toner. The method comprises in a first step 501 developing a first latent image by transferring first liquid toner having a first colour onto a first imaging member of a first image forming unit, in accordance with a first pattern of electric charges and transferring first liquid toner from the first imaging member to a substrate, in accordance with the first pattern, whilst the substrate is compressed in a first nip. The compressing of the substrate in the first step 501 results in an increased width of the substrate, after the first image forming step 501, seen in a direction perpendicular on a movement direction of the substrate. During the first step 501 left and right marks Pa, see also FIGS. 2A and 3 may be printed as part of the first image, in accordance with the first pattern. The marks Pa may be printed e.g. before the actual image or in the left and right margins of the substrate. In exemplary embodiments the marks may be part of the control strip, or the cut marks may be used as the marks Pa. In a second step 502 the marks Pa on the substrate may be detected e.g. by a camera and the distance wa between the marks Pa may be compared with the distance w0 between the marks Pa0 as present on the first imaging member. Based on the difference between wa and w0, the image processing system may be controlled to adjust the second pattern such that the second pattern is aligned with the first pattern and compensates for the expansion of the substrate S, see step 503. This may be done by adding a number of pixels corresponding with the width increase of the printable area of the substrate. These pixels may be added by inserting a suitable number of dummy pixels. The value of these dummy pixels may be determined e.g. by replicating an adjacent left or right pixel value or by performing an interpolation between at least one adjacent left and right pixel value. More generally the value of the dummy pixel may be determined based on one or more values of one or more neighbouring pixels. For example, for a substrate having a width equal to 50 cm, the width of the printable area of the substrate is 48.4 cm. In an exemplary embodiment the width increase of the printable area, as derived from the measurement of marks Pa is between 0.2 and 0.3 mm, e.g. 0.25 mm. When the resolution is 1200 dpi for a width increase of the printable area of 0.25 mm, 12 dummy pixels are inserted, i.e. one dummy pixel for every 1906 pixels. The third and fourth pattern may be adjusted in a similar manner as the second pattern, with an optional additional adjustment for the further width increase(s).

In step 504 a second latent image is developed by transferring second liquid toner having a second colour onto a second imaging member of a second image forming unit, in accordance with the adjusted second pattern of electric charges; and second liquid toner is transferred from the second imaging member to the substrate in accordance with the adjusted second pattern, whilst the substrate is compressed. During step 504 marks Pb′ may be printed in the second colour, e.g. before the actual image is being printed or in the margins of the substrate. Similarly during step 505 a third image with marks Pc′ may be printed in the third colour, and during a further step 506 a fourth image with marks Pd′ may be printed in the fourth colour.

In step 507 the distance Δwab′ between marks Pa and Pb′, the distance Δwac′ between marks Pa and Pc′, and the distance Δwad′ between marks Pa and Pd′ is measured, e.g. using a camera. These distances Δwab′, Δwac′ and Δwad′ may then be used to determine the further width increases after the second, third and fourth image forming steps 504, 505, 506, respectively. Based on these determined further width increases of the printable area of the substrate, in step 508, the second and/or third and/or fourth pattern may be further adjusted to further improve the alignment between the first, second, third and fourth pattern.

The adjusting in steps 503 and 508 preferably comprises adjusting a bitmap generated by a raster image processor, whereupon control signals for the first, second, third and fourth imaging members can be generated based on the adjusted bitmap.

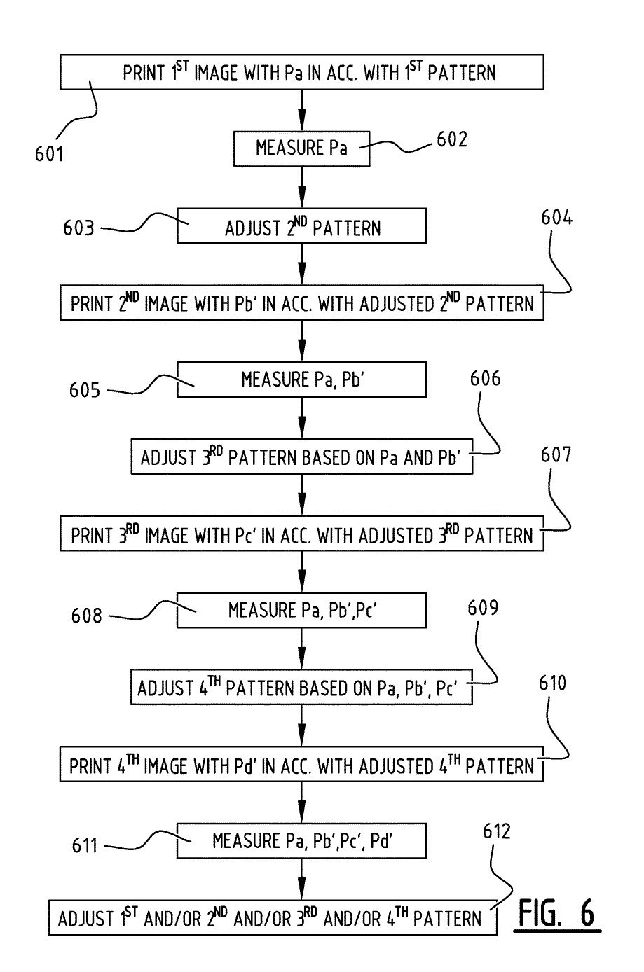

FIG. 6 illustrates another exemplary embodiment of a digital printing method using liquid toner. The method comprises a first step 601 which is identical to step 501 and consists in printing a first image with marks Pa in a first colour, in accordance with a first pattern of electric charges. The compressing of the substrate in first step 601 results in an increased width of the substrate when the substrate leaves the first nip. In a second step 602 the marks Pa on the substrate may be detected e.g. by a camera and the distance wa between the marks Pa may be compared with the distance w0 between the marks Pa0 in the first pattern. Based on the difference between wa and w0, the image processing system may be controlled to adjust the second pattern such that the second pattern is aligned with the first pattern and compensates for the expansion of the substrate S due to the compressing during the first step 601, see step 603.

In step 604 a second image including marks Pb′ is printed in a second colour, in accordance with the adjusted second pattern, as in step 504 of FIG. 5. In step 605 the distance Δwab′ between marks Pa and Pb′ is measured, and in step 606 the third pattern is adjusted in function of the distance Δwab′. For example, a suitable number of dummy pixels may be inserted in the third pattern to compensate for the width increase of the substrate due to step 604.

Next in step 607 a third image with marks Pc′ may be printed in the third colour, in accordance with the adjusted third pattern. In step 608 the distance Δwac′ between marks Pa and Pc′ is measured, and in step 609 the fourth pattern is adjusted in function of the distance Δwac′. For example, a suitable number of dummy pixels may be inserted in the fourth pattern to compensate for the width increase of the substrate due to step 607.

Next in step 610 a fourth image with marks Pd′ may be printed in the fourth colour, in accordance with the adjusted fourth pattern. In step 611 the distance Δwad′ between marks Pa and Pd is measured, and in step 612 the first and/or second and/or third and/or fourth pattern may be further adjusted in function of the distance Δwad′.

The adjusting in steps 603, 606, 609 and 612 preferably comprises adjusting a bitmap generated by a raster image processor, whereupon control signals for the first, second, third and fourth imaging members can be generated based on the adjusted bitmap.

In yet other non-illustrated embodiments the marks Pa, Pb, Pc, Pd may be printed first, as in FIG. 3, without performing any corrections, and next the width increases at the subsequent stages may be determined. An adjustment of the patterns may then be performed during subsequent printing, based on the determined width increases.

Typically the steps of FIG. 5 or FIG. 6 may be repeated a number of times to further optimize the alignment of the patterns. Further the measuring and adjusting steps may be performed at regular intervals during normal operation of the machine so that the compensation remains good, also when an operating condition which influence the expansion of the substrate changes.

Particular embodiments of the invention relate to the field of digital printing apparatus and methods for so-called “continuous” webs, i.e. printing systems where a continuous roll of substrate (e.g., paper, plastic foil, or a multi-layer combination thereof) is run through the printer, in particular to print large numbers of copies of the same image(s), or alternatively, series of images, or even large sets of individually varying images

A person of skill in the art would readily recognize that steps of various above described methods can be performed by programmed computers. Herein, some embodiments are also intended to cover program storage devices, e.g., digital data storage media, which are machine or computer readable and encode machine executable or computer-executable programs of instructions, wherein said instructions perform some or all of the steps of said above-described methods. The program storage devices may be, e.g., digital memories, magnetic storage media such as a magnetic disks and magnetic tapes, hard drives, or optically readable digital data storage media. The embodiments are also intended to cover computers programmed to perform said steps of the above-described methods.

The functions of the various elements shown in the figures, including any functional blocks labelled as “processors”, may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read only memory (ROM) for storing software, random access memory (RAM), and non volatile storage. Other hardware, conventional and/or custom, may also be included.

Whilst the principles of the invention have been set out above in connection with specific embodiments, it is to be understood that this description is merely made by way of example and not as a limitation of the scope of protection which is determined by the appended claims.

1. A digital printing apparatus using liquid toner comprising a carrier liquid, a dispersing agent and imaging particles, the apparatus comprising:
a first image forming unit for a first colour comprising a first imaging member adapted to sustain a first pattern of electric charge forming a first latent image on its surface; and a first development member arranged to receive first liquid toner, and to develop said first latent image by transferring a portion of said first liquid toner onto said first imaging member in accordance with said first pattern;
a second image forming unit for a second colour comprising a second imaging member adapted to sustain a second pattern of electric charge forming a second latent image on its surface;
and a second development member arranged to receive second liquid toner, and to develop said second latent image by transferring a portion of said second liquid toner onto said second imaging member in accordance with said second pattern;
a substrate support assembly for supporting the substrate during the subsequent transfer of first liquid toner and second liquid toner from the first image forming unit and the second image forming unit to the substrate, while the substrate moves in a movement direction from the first image forming unit to the second image forming unit;
with the second image forming unit arranged downstream of the first image forming unit along the substrate support assembly;
wherein the first image forming unit and the substrate support assembly are arranged such that the substrate is compressed in a first nip between the first image forming unit and the substrate support assembly, when first liquid toner is transferred to the substrate, resulting in an increased width of the substrate, seen in a direction perpendicular on the movement direction of the substrate, when the substrate leaves the first nip; and
a control mechanism configured for adjusting said first pattern and/or second pattern in order to compensate for the increased width of the substrate downstream of the first image forming unit.

2. The digital printing apparatus of claim 1, wherein the first image forming unit comprises a first intermediate member between the first imaging member and the substrate support assembly, and wherein the second image forming unit comprises a second intermediate member between the second imaging member and the substrate support assembly.

3. The digital printing apparatus of claim 2, wherein the substrate support assembly comprises a first support member and a second support member, and wherein the first support member is arranged in rotating contact with the first intermediate member and the second support member is arranged in rotating contact with the second intermediate member, such that in operation a substrate is compressed between the first support member and the first intermediate member and between the second support member and the second intermediate member.

4. The digital printing apparatus of claim 1, wherein the control mechanism is configured to add pixels to the second pattern to compensate for the increased width of the substrate downstream of said first image forming unit.

5. The digital printing apparatus of claim 1, further comprising a sensing mechanism configured to sense a measure representative for the width of the substrate downstream of the first image forming unit; and wherein the control mechanism is configured to adjust the first pattern and/or the second pattern in function of the sensed measure.

6. The digital printing apparatus of claim 5, wherein the sensing mechanism is configured to measure, downstream of the first image forming unit, a distance between marks printed by the first image forming unit, in a direction perpendicular to the movement direction of the substrate.

7. The digital printing apparatus of claim 5, wherein the sensing mechanism comprises a first sensor configured to sense a first measure representative for the width of the substrate downstream of the first image forming unit and upstream of the second image forming unit; and/or a second sensor configured to sense a second measure representative for the width increase of the substrate downstream of the second image forming unit; and wherein the control mechanism is configured to adjust the first pattern and/or the second pattern in function of the first sensed measure and/or the second sensed measure.

8. The digital printing apparatus of claim 7, wherein the second sensor is configured to sense a position difference, seen in a width direction perpendicular to the movement direction of the substrate, between a first mark printed in the first colour and a second mark printed in the second colour.

9. The digital printing apparatus of claim 1, wherein a substrate is arranged between the first image forming unit and the substrate support assembly; and wherein the first image forming unit and the substrate support assembly are arranged and configured such that the first nip has a length, seen in the direction of movement of the substrate, which is bigger than 6 mm, preferably bigger than 7 mm, and more preferably bigger than 8 mm.

10. The digital printing apparatus of claim 1, wherein a substrate is arranged between the first image forming unit and the substrate support assembly; and wherein the first image forming unit and the substrate support assembly are configured to compress of the substrate such that the increase of the width of the substrate is above 1 mm per 50 cm, and more preferably above 2 mm per 50 cm.

11. The digital printing apparatus of claim 1, further comprising an image processing system for generating control signals for the first and second image forming unit, from source image data from an image source, the image processing system comprising:
a raster image processing module configured to convert the source image data into a bitmap; and
a streaming processor configured to receive the bitmap and to generate control signals for the first image forming unit and the second image forming unit based on the bitmap; wherein the control mechanism is implemented in the streaming processor.

12. A digital printing method using liquid toner comprising a carrier liquid, a dispersing agent and imaging particles, the method comprising:
developing a first latent image by transferring a first liquid toner having a first colour onto a first imaging member of a first image forming unit, in accordance with a first pattern of electric charges; and transferring the first liquid toner from the first imaging member to a substrate;
developing a second latent image by transferring a second liquid toner having a second colour onto a second imaging member of a second image forming unit, in accordance with a second pattern of electric charges; and transferring the second liquid toner from the second imaging member to the substrate;
wherein the substrate is compressed in a first nip when the first liquid toner is transferred to the substrate, resulting in an increased width of the substrate, seen in a direction perpendicular on a movement direction of the substrate from the first image forming unit to the second image forming unit; and
adjusting the first pattern and/or the second pattern in order to compensate for the increased width of the substrate downstream of the first image forming unit.

13. The digital printing method of claim 12, wherein the adjusting comprises adding pixels to the second pattern to compensate for the increased width of the substrate downstream of said first image forming unit.

14. The digital printing method of claim 12, further comprising sensing a measure representative for the width of the substrate downstream of the first image forming unit; and wherein the adjusting comprises adjusting the first pattern and/or the second pattern in function of the sensed measure.

15. The digital printing method of claim 14, wherein the sensing comprises measuring, downstream of the first image forming unit, a distance between marks printed by the first image forming unit, in a direction perpendicular on the movement direction of the substrate.

16. The digital printing method of claim 14, wherein the sensing comprises sensing a first measure representative for the width of the substrate downstream of the first image forming unit and upstream of the second image forming unit; and/or sensing a second measure representative for the width increase of the substrate downstream of the second image forming unit; and wherein the adjusting comprises adjusting the first pattern and/or the second pattern in function of the first sensed measure and/or the second sensed measure.

17. The digital printing method of claim 12, wherein the first nip has a length, seen in the direction of movement of the substrate, which is bigger than 6 mm, preferably bigger than 7 mm, and more preferably bigger than 8 mm.

18. The digital printing method of claim 12, wherein the compressing of the substrate is such that the increase of the width of the substrate is above 1 mm per 50 cm, and more preferably above 2 mm per 50 cm.

19. The digital printing method of claim 12, further comprising:
converting source image data into a bitmap; and
generating control signals for the first image forming unit and the second image forming unit based on the bitmap; wherein the adjusting comprises adjusting the bitmap before the control signals are being generated.

20. A computer program product comprising computer-executable instructions for performing the adjusting step of the method according to claim 13, when the program is run on a computer.
